(19) United States
(12) Patent Application Publication
(10) Pub. No.: US 2026/0252206 A1
(43) Pub. Date: Aug. 27, 2026

(54) METHOD AND APPARATUS FOR GENERATING VARIOUS EFFECTS ON BASIS OF CONTENT OF OBJECT OF INTEREST

(71) Applicant: SAMSUNG ELECTRONICS CO., LTD., Suwon-si (KR)

(72) Inventors: Dukhyun KIM, Suwon-si (KR); Sangheon KIM, Suwon-si (KR); Junsung KIM, Suwon-si (KR); Dongil SON, Suwon-si (KR); Yoechan SONG, Suwon-si (KR); Yeunwook LIM, Suwon-si (KR)

(73) Assignee: SAMSUNG ELECTRONICS CO., LTD., Suwon-si (KR)

(21) Appl. No.: 19/651,267

(22) Filed: Apr. 17, 2026

Related U.S. Application Data
(63) Continuation of application No. PCT/KR2024/010848, filed on Jul. 25, 2024.

(30) Foreign Application Priority Data
Oct. 18, 2023 (KR) 10-2023-0139718
Nov. 23, 2023 (KR) 10-2023-0164568

(51) Int. Cl. G06F 3/0481; G06V 10/22

(52) U.S. Cl. CPC G06F 3/0481; G06V 10/235

(57) ABSTRACT

An electronic device is provided. The electronic device includes at least one processor, and a memory configured to store instructions. The instructions, when performed by the at least one processor, cause the electronic device to detect an occurrence of an event related to an object of interest disposed or to be disposed on a screen of the electronic device, generate a prompt based on the occurred event, and determine an effect to be applied to the electronic device or an external device communicatively connected to the electronic device based on the generated prompt.

### CROSS-REFERENCE TO RELATED APPLICATIONS

This application is a Continuation Application of International Application PCT/KR2024/010848, filed on July 25, 2024, which claims benefit of Korean Patent Application No. 10-2023-0139718, filed on October 18, 2023, at the Korean Intellectual Property Office and Korean Patent Application No. 10-2023-0164568, filed on November 23, 2023, at the Korean Intellectual Property Office, the disclosures of which are incorporated herein in their entireties by reference.

### FIELD

The present disclosure generally relates to and, more particularly to a technology for generating various effects based on content of an object of interest.

### BACKGROUND

Electronic devices may dispose objects such as icons and widgets on a screen. Traditionally, electronic devices have mainly displayed various information (e.g., weather information, stock information, etc.) within an area of a widget or have applied simple effects such as visual animation effects within the area of the widget. However, in the related art, electronic devices mainly applied effects to an internal area of the widget, and were unable to apply effects to portions outside the area of the widget or to external devices other than the electronic device, which resulted in limitations in terms of user experience.

### SUMMARY

According to an aspect of the present disclosure, there is provided an electronic device. The electronic device includes at least one processor, and a memory configured to store instructions. The instructions, when performed by the at least one processor, cause the electronic device to detect an occurrence of an event related to an object of interest disposed or to be disposed on a screen of the electronic device, generate a prompt based on the occurred event, and determine an effect to be applied to the electronic device or an external device communicatively connected to the electronic device based on the generated prompt.

According to an aspect of the present disclosure, there is provided a method performed by at least one processor of an electronic device. The method includes detecting an occurrence of an event related to an object of interest disposed or to be disposed on a screen of the electronic device, generating a prompt based on the occurred event, and determining an effect to be applied to the electronic device or an external device communicatively connected to the electronic device based on the generated prompt.

### BRIEF DESCRIPTION OF DRAWINGS

The above and other aspects and features of certain embodiments of the present disclosure will be more apparent from the following description taken in conjunction with the accompanying drawings, in which:

FIG. 1 is a block diagram of an electronic device in a network environment according to an embodiment;

FIG. 2 is a diagram schematically illustrating a process in which an electronic device detects occurrence of an event related to an object of interest to apply an effect to the electronic device or an external device communicatively connected to the electronic device, according to an embodiment;

FIG. 3 is a diagram illustrating a process in which an electronic device detects occurrence of an event and generates a prompt when a widget is set as an object of interest, according to an embodiment;

FIG. 4A is a diagram illustrating a process in which an electronic device detects occurrence of an event when a widget is set as an object of interest, according to an embodiment;

FIG. 4B is a diagram illustrating a process in which an electronic device generates a prompt when a widget is set as an object of interest, according to an embodiment;

FIG. 5 is a diagram illustrating a process in which an electronic device detects occurrence of an event and generates a prompt when a window is set as an object of interest, according to an embodiment;

FIG. 6 is a diagram illustrating a process in which an electronic device detects an object on a screen and identifies a feature and a position of the detected object, according to an embodiment;

FIG. 7 is a diagram illustrating a process for determining an effect based on a prompt by an electronic device according to an embodiment;

FIG. 8 is a diagram illustrating a process in which an electronic device applies a visual effect to another object disposed around an object of interest according to an embodiment;

FIGS. 9 and 10 are diagrams illustrating a process in which an electronic device detects occurrence of an event related to a widget to apply a visual effect related to a background image, according to an embodiment; and

FIG. 11 is a diagram illustrating a process in which an electronic device detects occurrence of an event related to a window to apply a visual effect to the electronic device according to an embodiment.

### DETAILED DESCRIPTION

Hereinafter, embodiments will be described in detail with reference to the accompanying drawings. When describing the embodiments with reference to the accompanying drawings, like reference numerals refer to like components and a repeated description related thereto will be omitted.

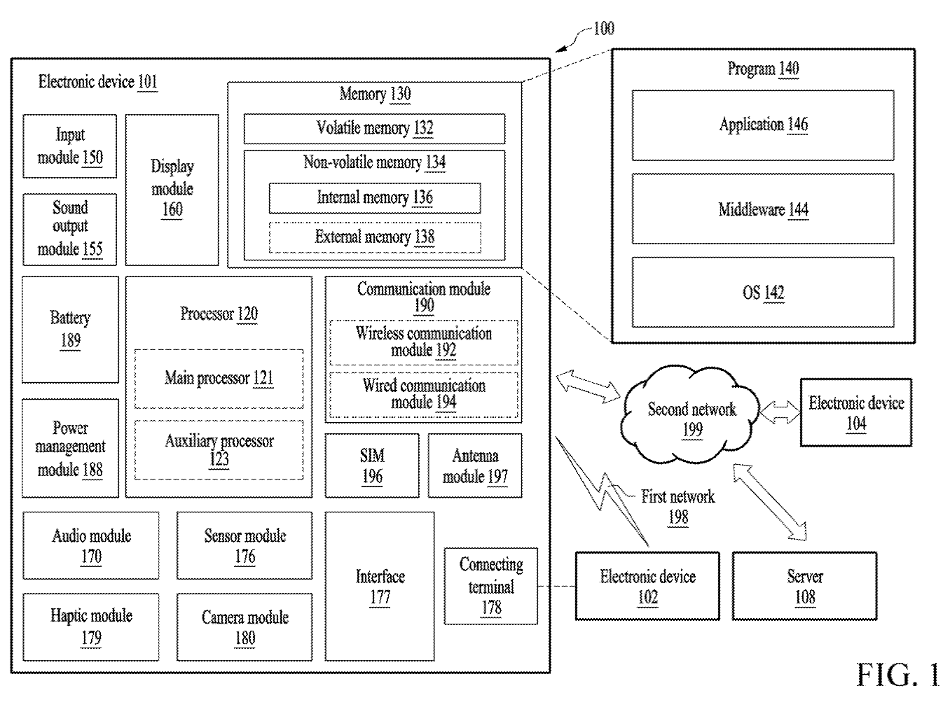

FIG. 1 is a block diagram illustrating an electronic device 101 in a network environment 100 according to an embodiment. Referring to FIG. 1, the electronic device 101 in the network environment 100 may communicate with an electronic device 102 via a first network 198 (e.g., a short-range wireless communication network), or communicate with an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include at least one processor 120 (hereinafter, the “processor”), memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added to the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121 or to be dedicated for a designated function. The auxiliary processor 123 may be implemented separately from the main processor 121 or as a part of the main processor 121.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state, or together with the main processor 121 while the main processor 121 is an active state (e.g., executing an application). According to an embodiment, the auxiliary processor 123 (e.g., an ISP or a CP) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence (AI) model processing. An AI model may be generated through machine learning (ML). Such learning may be performed, for example, by the electronic device 101 in which an AI model is executed, or via a separate server (e.g., the server 108). Learning algorithms may include, but are not limited to, e.g., supervised learning, unsupervised learning, semi-supervised learning, or reinforcement learning. The AI model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network or a combination of two or more thereof, but is not limited thereto. The AI model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electric signal or vice versa. According to an embodiment, the audio module 170 may obtain the sound via the input module 150, or output the sound via the sound output module 155 or an external electronic device (e.g., the electronic device 102 such as a speaker or headphones) directly or wirelessly connected to the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wired) or wirelessly. According to an embodiment, the interface 177 may include, for example, a high definition multimedia interface (HDMI), a universal serial bus (USB) interface, a secure digital (SD) card interface, or an audio interface.

The connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or an electrical stimulus which may be recognized by a user via his or her tactile sensation or kinesthetic sensation. According to an embodiment, the haptic module 179 may include, for example, a motor, a piezoelectric element, or an electric stimulator.

The camera module 180 may capture a still image and moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is non-rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently from the processor 120 (e.g., the AP) and support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) and/or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164dB or less) for implementing mMTC, or U-plane latency (e.g., 0.5ms or less for each of downlink (DL) and uplink (UL), or a round trip of 1ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may be transmitted or received between the communication module 190 and the external electronic device via the at least one selected antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the components described above may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic device 102 or external electronic device 104 may be a device of the same type as, or a different type, from the electronic device 101. According to an embodiment, all or some of operations to be executed at the electronic device 101 may be executed at one or more of the external electronic devices (e.g., the external electronic devices 102 and 104, or the server 108). For example, if the electronic device 101 should perform a function or a service automatically, or in response to a request from a user or another device, the electronic device 101, instead of, or in addition to, executing the function or the service, may request the one or more external electronic devices (e.g., the external electronic devices 102 and 104) to perform at least part of the function or the service. The one or more external electronic devices (e.g., the external electronic devices 102 and 104) receiving the request may perform the at least part of the function or the service requested, or an additional function or an additional service related to the request and may transfer an outcome of the performing to the electronic device 101. The electronic device 101 may provide the outcome, with or without further processing of the outcome, as at least part of a reply to the request. To that end, cloud computing, distributed computing, mobile edge computing (MEC), or client-server computing technology may be used, for example. The electronic device 101 may provide ultra-low-latency services using, e.g., distributed computing or MEC. In an embodiment, the external electronic device (e.g., the electronic device 104) may include an Internet-of-Things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

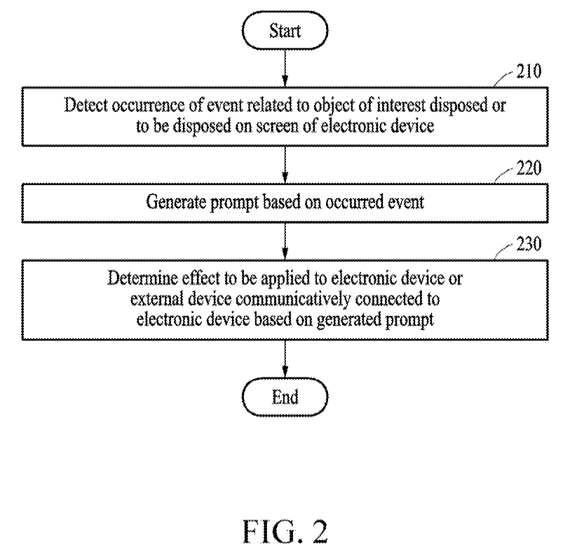

FIG. 2 is a diagram schematically illustrating a process in which an electronic device detects occurrence of an event related to an object of interest to apply an effect to the electronic device or an external device communicatively connected to the electronic device, according to an embodiment.

In operation 210, the electronic device may detect occurrence of an event related to an object of interest disposed or to be disposed on a screen, e.g., displayed or to be displayed on a screen.

In an embodiment, the electronic device may set at least one of a widget and a window as an object of interest. However, the object of interest that may be set by the electronic device is not limited thereto, and an object (e.g., an icon) disposed or to be disposed on the screen may be set as the object of interest. Hereinafter, for convenience of description, a case where the electronic device sets a widget or a window as the object of interest is mainly described. A widget may represent a dynamic user interface element for providing real-time information and an interaction with a user on a (home) screen of the electronic device. A window may represent an independent window that allows the user to interact with an application and display content.

In an embodiment, the electronic device may detect the occurrence of the event in a variety of ways depending on the type of object of interest to be set. An object of interest may refer to an object related to the occurred event when the occurrence of the event is detected. For example, when the widget is set as the object of interest, the electronic device may detect a change in a content displayed in an area of the widget or an overlap of areas corresponding to a plurality of widgets, as the occurrence of the event. In another example, when the window is set as the object of interest, the electronic device may detect displaying a new window on the screen of the electronic device, as the occurrence of the event.

In operation 220, the electronic device may generate a prompt based on the occurred event.

In an embodiment, the electronic device may generate the prompt using first information related to a content displayed on the object of interest. In an embodiment, the electronic device may generate the prompt using second information related to an external device communicatively connected to the electronic device, as well as the first information related to the content displayed on the object of interest.

In operation 230, the electronic device may determine an effect to be applied to the electronic device or the external device communicatively connected to the electronic device based on the generated prompt.

In an embodiment, the electronic device may input the generated prompt to a generative AI model, which is a type of machine learning model. The generative AI model may output an effect to be applied to the electronic device or an external device (e.g., the electronic device 102 or the electronic device 104 of FIG. 1) communicatively connected to the electronic device based on the input prompt. Here, the effect may include at least one of a visual effect, a tactile effect, and an auditory effect. The electronic device may improve user experience (UX) by applying the determined effect to the electronic device or the external device.

According to an embodiment, the electronic device may an object other than the object of interest, as the object to which the effect is to be applied. In various embodiments of the disclosure, when the electronic device determines the object other than the object of interest as the object, to which the effect is to be applied, the determined other object may be referred to as a “target object.” The electronic device may determine the target object based on the position where each object is disposed. According to an embodiment, the electronic device may determine an effect to be applied, and then determine a target object, to which the determined effect is to be applied. The electronic device according to an embodiment may determine the target object, to which an effect is to be applied, and then determine the effect to be applied to the determined target object. However, the determination of the effect and the determination of the target object are not limited to being performed sequentially, and the determination of the effect to be applied and the determination of the target object may be performed independently (e.g., in parallel).

According to an embodiment, the electronic device may apply the effect to both the electronic device and the external device. The electronic device may determine a first effect to be applied to the electronic device and a second effect to be applied to the external device. The electronic device may determine a first target object, to which the first effect is to be applied, and a second target object, to which the second effect is to be applied. The first effect and the second effect may be different from each other, but are not limited thereto, and the first effect and the second effect may be the same. Similarly, the first target object and the second target object may be different from each other, but are not limited thereto, and the first target object and the second target object may be the same.

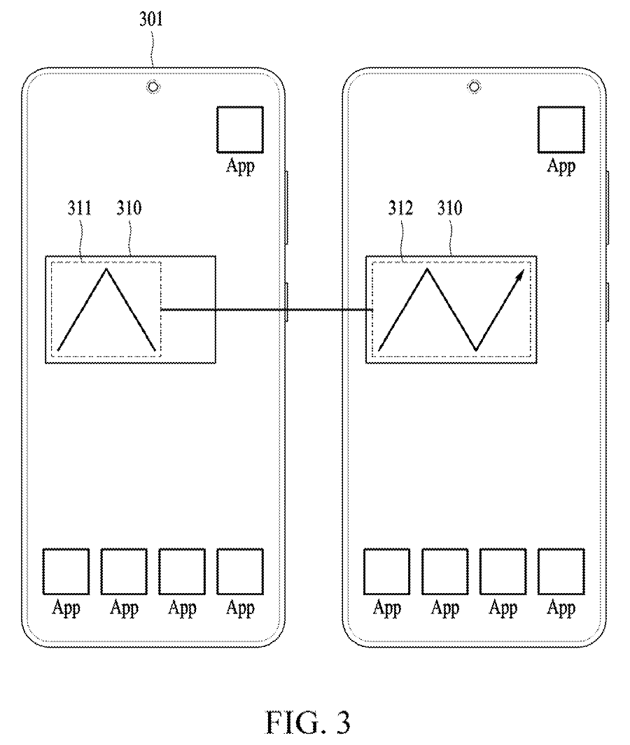

FIG. 3 is a diagram illustrating a process in which an electronic device detects occurrence of an event and generates a prompt when a widget is set as an object of interest, according to an embodiment.

In an embodiment, an electronic device 301 (e.g., the electronic device 101 of FIG. 1) may set a widget (e.g., a widget 310) disposed on a screen of the electronic device 301 as the object of interest.

In an embodiment, when the widget is set as the object of interest, the electronic device 301 may detect a change in a content 311 displayed in an area of the first widget 310 disposed on the screen of the electronic device 301 as the occurrence of the event. The change in content may represent, for example, a change in visual image, but is not limited thereto.

In an embodiment, the electronic device 301 may compare the first content 311 displayed in the area of the first widget 310 at a first time point and a second content 312 displayed in the area of the first widget 310 at a second time point. The electronic device 301 may determine that the first content 311 at the first time point and the second content 312 at the second time point are different from each other. The second time point may be, for example, a time point subsequent to the first time point. In other words, the electronic device 301 may detect a change in the content (e.g., the first content 311 and the second content 312) displayed in the area of the first widget 310 on the screen, and determine that an event has occurred when the change in the content is detected.

In an embodiment, the electronic device 301 may generate a prompt using first information related to the content (e.g., the first content 311 and the second content 312) displayed in the area of the first widget 310 on the screen. The first information related to the content displayed in the area of the first widget 310 may include at least one of difference information or description information. The difference information may indicate a difference between a previous content (e.g., the first content 311) displayed in the area of the first widget 310 at a previous time point (e.g., the first time point) and a current content (e.g., the second content 312) displayed in the area of the first widget 310 at a current time point (e.g., the second time point). The description information may describe the content (e.g., the second content 312) displayed in the area of the first widget 310 at a current time point (e.g., the second time point).

Referring to FIG. 3, the difference information may include information indicating that a stock chart has changed from a downward curve to an upward curve, which is information indicating the difference between the first content 311 and the second content 312. The description information may include information indicating that the stock chart shows an upward curve pointing to the right, information indicating that the curve of the stock chart has a red color, and information indicating that a shape of an end of the curve of the stock chart is an arrow shape, which are information describing the second content 312.

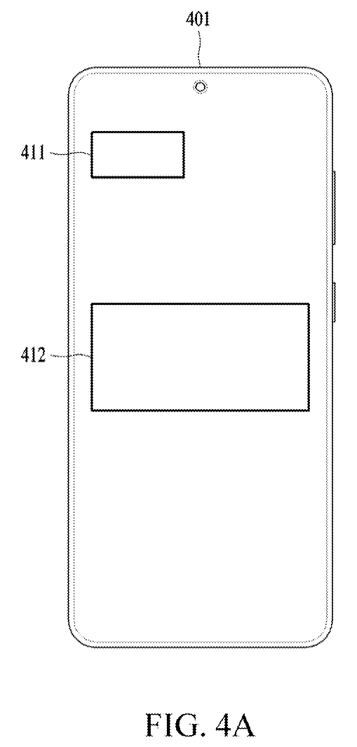

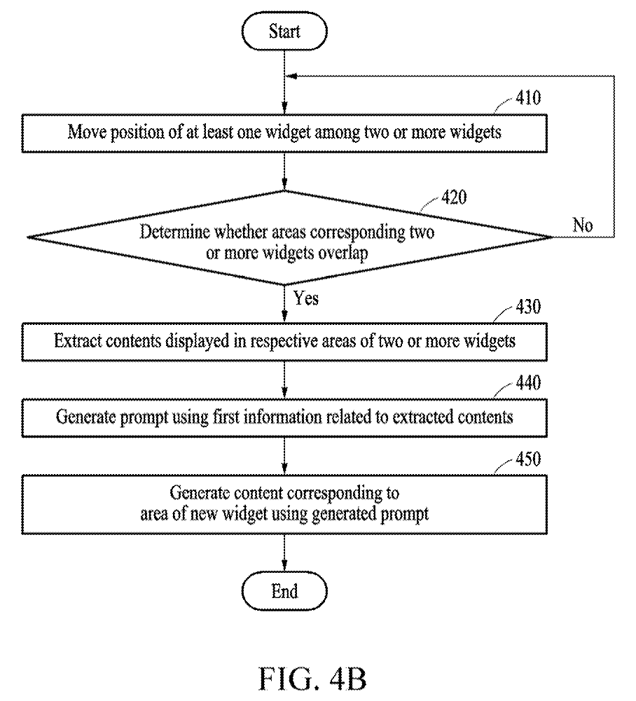

FIG. 4A is a diagram illustrating a process in which an electronic device detects occurrence of an event when a widget is set as an object of interest, according to an embodiment.

In an embodiment, an electronic device 401 (e.g., the electronic device 101 of FIG. 1 or the electronic device 301 of FIG. 3) may set a widget (e.g., a widget 411 or a widget 412) disposed on a screen of the electronic device 301 as the object of interest.

In an embodiment, when the widget is set as the object of interest, the electronic device 401 may detect an overlap of areas corresponding to two or more widgets 411 and 412 disposed on a screen of the electronic device 401 as the occurrence of the event. The overlap of the areas corresponding to the two or more widgets 411 and 412 may indicate that a portion of an area corresponding to the second widget 411 and a portion of an area corresponding to the third widget 412 overlap. For example, the electronic device 401 may change an area in which the widget (e.g., the second widget 411 or the third widget 412) is disposed on the screen through a user input, and the areas corresponding to the two or more widgets 411 and 412 may overlap by a movement of the widget (e.g., the second widget 411 or the third widget 412). In this case, the electronic device 401 may determine that an event has occurred by detecting that the areas corresponding to the two or more widgets 411 and 412 overlap on the screen.

FIG. 4B is a diagram illustrating a process in which an electronic device generates a prompt when a widget is set as an object of interest, according to an embodiment.

In an embodiment, the electronic device 401 may generate a prompt using first information related to contents displayed in the respective areas of the two or more widgets 411 and 412 disposed on the screen. Here, the first information related to the contents displayed in the respective areas of the two or more widgets 411 and 412 may include description information describing the content displayed in the area of the second widget 411 at a current time point and description information describing the content displayed in the area of the third widget 412 at the current time. The current time point may refer to a time point at which an event has occurred. For example, the current time point may include a time point at which the overlap of the areas corresponding to the widgets 411 and 412 has occurred.

In operation 410, the electronic device 401 may move a position of at least one widget among the two or more widgets 411 and 412 disposed on the screen. As described above, the electronic device 401 may move the position of the at least one widget among the two or more widgets 411 and 412 based on a user input. Moving the position of a widget may refer to changing an area of the widget on the screen.

In operation 420, the electronic device 401 may determine whether the areas corresponding to the two or more widgets 411 and 412 overlap. When it is determined that the areas corresponding to the two or more widgets 411 and 412 overlap, the electronic device 401 may wait for the performing of operation 410. In other words, the electronic device 401 may wait for the areas corresponding to the two or more widgets 411 and 412 to overlap.

In operation 430, when it is determined that the areas corresponding to the two or more widgets 411 and 412 overlap, the electronic device 401 may extract contents displayed in the respective areas of the two or more widgets 411 and 412.

In operation 440, the electronic device 401 may generate the prompt using the first information related to the extracted contents.

In an embodiment, the electronic device 401 may obtain the first information by extracting the contents displayed in the respective areas of the two or more widgets 411 and 412 and analyzing each of the extracted contents.

In an embodiment, the electronic device 401 may generate a new widget by merging the two or more widgets 411 and 412. For example, the electronic device 401 may merge (or connect) the areas corresponding to the two or more widgets 411 and 412, and define the merged area as an area of the new widget. For example, the electronic device 401 may remove the two or more widgets 411 and 412 from the screen, and define the area of the new widget as a new area unrelated to the areas corresponding to the two or more widgets 411 and 412.

In an embodiment, the electronic device 401 may generate a prompt using the first information related to the contents extracted from the two or more widgets 411 and 412 and information on a size and a shape of the area corresponding to the new widget.

In operation 450, the electronic device 401 may generate a content corresponding to the area of the new widget using the generated prompt.

In an embodiment, the electronic device 401 may obtain the content corresponding to the area of the new widget based on inputting the generated prompt into a generative AI model. The electronic device 401 may display the generated content in the area of the new widget.

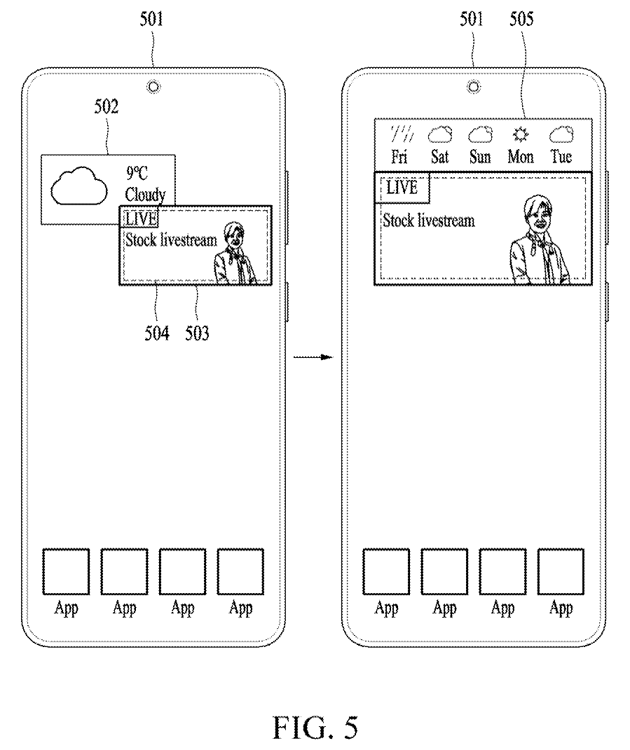

FIG. 5 is a diagram illustrating a process in which an electronic device detects occurrence of an event and generates a prompt when a window is set as an object of interest, according to an embodiment.

In an embodiment, an electronic device 501 (e.g., the electronic device 101 of FIG. 1, the electronic device 301 of FIG. 3, or the electronic device 401 of FIG. 4A) may set a window disposed or to be disposed on a screen of the electronic device 501 as an object of interest.

In an embodiment, when the window is set as the object of interest, the electronic device 501 may detect disposition of an additional window 503 on the screen of the electronic device 501 as the occurrence of the event. For example, the electronic device 501 may execute a function of a multi-window. The electronic device 501 may drive two or more applications on one screen through the function of the multi-window, thereby increasing user convenience.

In an embodiment, the electronic device 501 may activate the function of the multi-window. For example, the electronic device 501 may activate the function of the multi-window based on a user input. When the function of the multi-window is activated, the electronic device 501 may detect the disposition of an additional window (hereinafter, the “additional window 503”) (e.g., the additional window 503) on the screen in addition to an existing window being displayed (hereinafter, an “existing window”) as the occurrence of the event. In other words, the electronic device 501 may detect the additional window 503 being additionally output on the screen as the occurrence of the event.

For example, as shown in FIG. 5, the electronic device 501 may activate the function of the multi-window when displaying a widget 502 (e.g., a weather widget). The electronic device may dispose the additional window 503. The additional window 503 may include content related to stock. According to an embodiment, the electronic device may detect the occurrence of the event based on the disposition of the additional window 503 on the screen. When an overlap of an area corresponding to the widget 502 and an area of the additional window 503 is detected, the electronic device according to an embodiment may detect the overlap as the occurrence of the event.

In an embodiment, the electronic device 501 may generate a prompt using first information related to content (e.g., a content 504) displayed in the area of the additional window 503 disposed on the screen. Here, the first information related to the content displayed in the area of the additional window 503 may include description information describing the content displayed in the area of the additional window 503 at the current time point.

For example, in FIG. 5, the electronic device may generate the prompt using content (e.g., weather content) displayed in the area of the widget 502 and the first information related to content (e.g., content of stock) displayed in the area of the additional window 503. The electronic device may dispose a new window 505 while maintaining the function of the multi-window activated. The new window 505 may include a window modified from the additional window 503. The new window 505 may display weather content in a partial area of the new window 505, and display stock content in another partial area of the new window 505. The electronic device may obtain content corresponding to the new window 505 using the generated prompt.

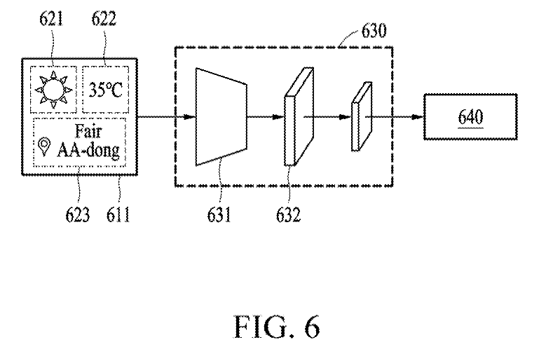

FIG. 6 is a diagram illustrating a process in which an electronic device detects an object on a screen and identifies a feature and a position of the detected object, according to an embodiment.

In an embodiment, an electronic device (e.g., the electronic device 101 of FIG. 1, the electronic device 301 of FIG. 3, the electronic device 401 of FIG. 4A, or the electronic device 501 of FIG. 5) may detect an object on a screen. The electronic device may identify a feature and a position of the detected object.

In an embodiment, the electronic device may detect one or more objects (e.g., an object 621, an objects 622, and an object 623) from an image 611 displayed on the screen of the electronic device, and identify features and positions of the detected one or more objects.

More specifically, the electronic device may detect the one or more objects (e.g., the object 621, the objects 622, and the object 623) from the input image 611 through object detection, based on inputting the input image 611 displayed on the screen to a visual foundation model 630, and identify the features and the positions of the detected one or more objects. One of the one or more objects (e.g., the object 621, the objects 622, and the object 623) detected from the input image 611 may be the object of interest.

For example, the electronic device may perform a stochastic operation to train the visual foundation model 630. The electronic device may perform the stochastic operation of applying noise (e.g., Gaussian noise) to the visual foundation model 630, and cause the visual foundation model 630 to operate under various input conditions through the stochastic operation.

The visual foundation model 630 may include an image encoder 631 and a detection decoder 632. The image encoder 631 may analyze the input image 611 to extract information related to a visual feature and convert the extracted information into a vector. The image encoder 631 may include, for example, a CNN. The detection decoder 632 may detect the objects (e.g., the object 621, the objects 622, and the object 623) disposed within the input image 611 based on the vector extracted from the image encoder 631, and identify feature and position information 640 of the detected objects. For example, the detection decoder 632 may identify the positions of the detected objects by generating bounding boxes for the detected objects (e.g., the object 621, the objects 622, and the object 623). Additionally, the detection decoder 632 may identify the features of the detected objects by predicting a class of content shown on the detected objects.

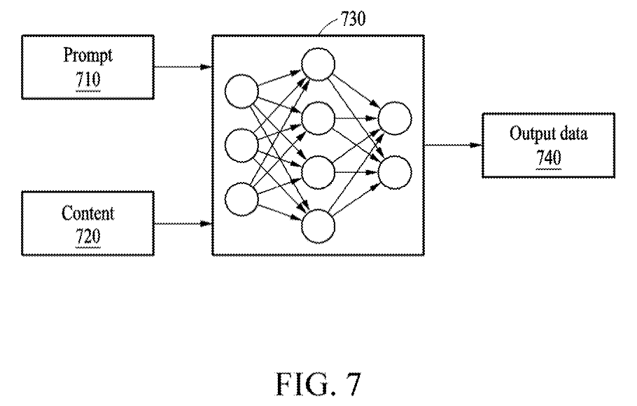

FIG. 7 is a diagram illustrating a process for determining an effect based on a prompt by an electronic device according to an embodiment.

In an embodiment, an electronic device (e.g., the electronic device 101 of FIG. 1, the electronic device 301 of FIG. 3, the electronic device 401 of FIG. 4A, or the electronic device 501 of FIG. 5) may determine an effect to be applied to the electronic device or an external device communicatively connected to the electronic device based on a prompt 710.

In an embodiment, the electronic device may obtain the effect to be applied to the electronic device or the external device based on inputting the prompt 710 to a generative AI model (e.g., a generative AI model 730), which is a type of ML model. The generative AI model 730 may be, for example, one of Dall-E 2, Stable Diffusion, Midjourney, and Imagen, but examples of the generative AI model 730 are not limited thereto. However, information other than the prompt 710 may also be additionally input into the generative AI model 730.

In an embodiment, the electronic device may obtain the effect to be applied to the electronic device or the external device based on inputting the prompt 710 and content 720 (e.g., the content 311 and the content 312 of FIG. 3) displayed on the object of interest to the generative AI model 730. Furthermore, the electronic device may also identify a device (e.g., the electronic device or the external device), to which the effect is to be applied, through output data 740 of the generative AI model 730. Here, the effect may include at least one of a visual effect, a tactile effect, and an auditory effect.

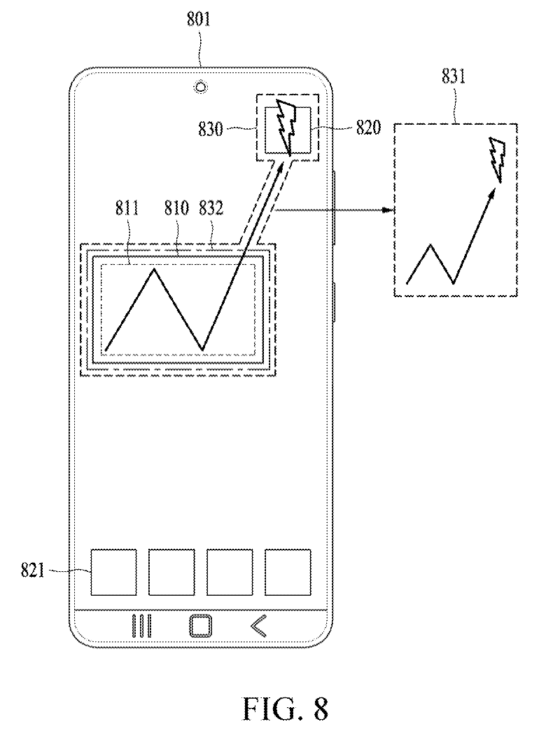

FIG. 8 is a diagram illustrating a process in which an electronic device applies a visual effect to another object disposed around an object of interest according to an embodiment.

In an embodiment, an electronic device 801 (e.g., the electronic device 101 of FIG. 1, the electronic device 301 of FIG. 3, the electronic device 401 of FIG. 4A, or the electronic device 501 of FIG. 5) may apply an effect output from a generative AI model (e.g., the generative AI model 730 of FIG. 7) to the electronic device 801. In FIG. 8, a case where the effect output from the generative AI model is a visual effect applied to the electronic device 801 is described.

In an embodiment, when the effect output from the generative AI model is a visual effect applied to the electronic device 801, the electronic device 801 may apply the visual effect to another object (e.g., an icon 820) disposed around a widget 810, which is the object of interest, on a screen of the electronic device 801. For example, the electronic device 801 may obtain a visual effect to be applied to the electronic device 801 based on inputting a content 811 and a prompt displayed on the widget 810 into the generative AI model.

In the example of FIG. 8, the electronic device 801 may obtain an image 831 to be applied to the electronic device 801 based on inputting the content 811 and the prompt of “stock chart, upward trend, upward curve” into the generative AI model. In other words, the generative AI model may generate the image 831.

In an embodiment, the electronic device 801 may select the other object (e.g., the icon 820), to which the visual effect is to be applied. In other words, the electronic device 801 may select the other object (e.g., the icon 820), to which the image 831 generated from the generative AI model is to be applied. The electronic device 801 may identify one or more objects (e.g., the widget 810, the icon 820, and an icon 821) disposed on the screen of the electronic device 801, and obtain position information of the identified one or more objects (e.g., the widget 810, the icon 820, and the icon 821). The electronic device 801 may select the other object (e.g., the icon 820) disposed around the widget 810, which is the object of interest, based on the position information of the one or more objects and the visual effect. For example, the electronic device 801 may determine an area (e.g., an area 830) on the screen used to display the image 831, and identify the other object (e.g., the icon 820) disposed in the determined area. At this time, in order to identify an object disposed in the determined area, the position information of the identified one or more objects on the screen may be used. The electronic device 801 may change a shape of the identified other object (e.g., the icon 820) (e.g., display a lighting shape). Additionally, the electronic device 801 may increase the area of the widget 810, and display a portion (e.g., a shape of a red curve rising to the right) of the image 831 generated in the increased area (e.g., the area 830). However, the electronic device 801 may maintain a bounding box corresponding to the widget 810 (e.g., a bounding box 832) displayed on the screen although the area (e.g., the area 830) of the widget 810 is increased. The area of the widget 810 may refer to an area where the content related to the widget 810 is disposed. The bounding box corresponding to the widget 810 may refer to an area set as a frame for displaying the widget 810.

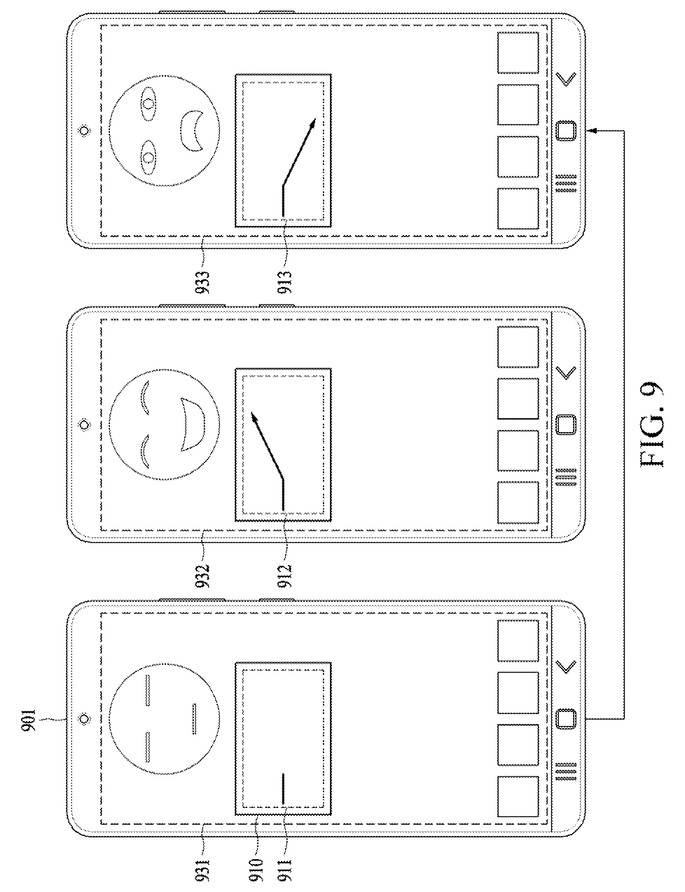

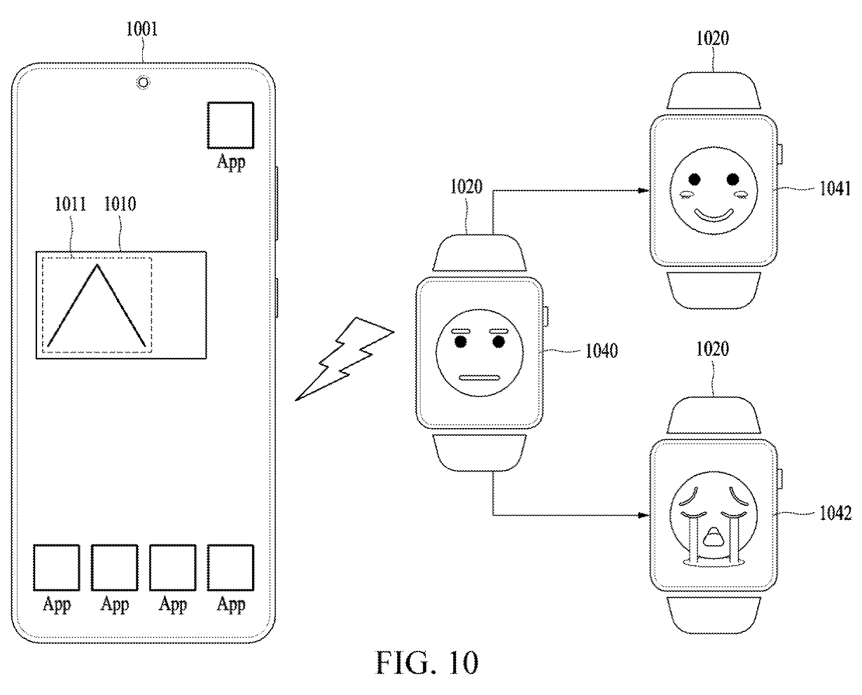

FIGS. 9 and 10 are diagrams illustrating a process in which an electronic device detects occurrence of an event related to a widget to apply a visual effect related to a background image, according to various embodiments.

FIG. 9 is a diagram illustrating a process in which an electronic device detects occurrence of an event related to a widget to apply a visual effect related to a background image of the electronic device according to an embodiment.

In an embodiment, an electronic device 901 (e.g., the electronic device 101 of FIG. 1, the electronic device 301 of FIG. 3, the electronic device 401 of FIG. 4A, the electronic device 501 of FIG. 5, or the electronic device 801 of FIG. 8) may set a widget as an object of interest, and detect, as the occurrence of the event, a change in content 911 displayed in an area of a widget 910 disposed on a screen of the electronic device 901. For example, the electronic device 901 may display the content 911 in the area of the widget 910 at a previous time point, and display content 912 or content 913 in the area of the widget 910 at a current time point. The electronic device 901 may apply a visual effect that changes the background image on the electronic device 901 based on the change in the content displayed in the area of the widget 910 over time.

For example, the electronic device 901 may generate a first prompt using first information related to the content displayed in the area of the widget 910 on the screen. The electronic device 901 may input the content 912 at the current time point, the first prompt of “stock chart, upward trend, rising curve”, and a background image 931 at the previous time point into a generative AI model, and the generative AI model may output the background image 931 at the previous time point by changing it into a background image 932. For example, when the background image 931 at the previous time point represents a face image with a blank expression, the background image 932 at the current time point may be a face image with a smiling expression.

For example, the electronic device 901 may generate a second prompt using the first information related to the content displayed in the area of the widget 910 on the screen. The electronic device 901 may input the content 913 at the current time point, the second prompt of “stock chart, downward trend, downward curve”, and the background image 931 at the previous time point into the generative AI model, and the generative AI model may output the background image 931 at the previous time point by changing it into a background image 933. For example, when the background image 931 at the previous time point represents a face image with a blank expression, the background image 933 at the current time point may be a face image with a crying expression.

FIG. 10 is a diagram illustrating a process in which an electronic device detects occurrence of an event related to a widget to apply a visual effect related to a background image of an external device communicatively connected to the electronic device according to an embodiment.

In an embodiment, an electronic device 1001 (e.g., the electronic device 101 of FIG. 1, the electronic device 301 of FIG. 3, the electronic device 401 of FIG. 4A, the electronic device 501 of FIG. 5, the electronic device 801 of FIG. 8, or the electronic device 901 of FIG. 9) may set a widget as an object of interest, and detect, as the occurrence of the event, a change in content 1011 displayed in an area of a widget 1010 disposed on a screen of the electronic device 1001. The electronic device 1001 may apply a visual effect that changes a background image on an external device (e.g., a wearable device 1020) communicatively connected to the electronic device 1001 based on the change in the content displayed in the area of the widget 1010 over time.

In an embodiment, the electronic device 1001 may generate a prompt using first information related to a content (e.g., a content 1011) displayed in an area of an object of interest (e.g., the widget 1010) disposed on the screen and second information related to the external device (e.g., the wearable device 1020) communicatively connected to the electronic device 1001. The second information may include information about a background image 1040 at a previous time point of the external device (e.g., a wearable device 1020).

For example, the electronic device 1001 may input a content at a current time point (e.g., the content 912 of FIG. 9), a second prompt of “stock chart, upward trend, rising curve, wearable device”, and the background image 1040 at the previous time point of the wearable device 1020 into a generative AI model, and the generative AI model may output the background image 1040 at the previous time point of the wearable device 1020 by changing it into a background image 1041. For example, when the background image 1040 at the previous time point of the wearable device 1020 represents an emoticon with a blank expression, the background image 1041 at the current time point may be an emoticon with a smiling expression.

For example, the electronic device 1001 may input a content at the current time point (e.g., the content 913 of FIG. 9), a second prompt of “stock chart, downward trend, downward curve, wearable device”, and the background image 1040 at the previous time point of the wearable device 1020 into the generative AI model, and the generative AI model may output the background image 1040 at the previous time point of the wearable device 1020 by changing it into a background image 1042. For example, when the background image 1040 at the previous time point of the wearable device 1020 represents an emoticon with a blank expression, the background image 1042 at the current time point may be an emoticon with a crying expression.

Referring to FIGS. 9 and 10, it is described that the electronic device (e.g., the electronic device 901 of FIG. 9 or the electronic device 1001 of FIG. 10) applies the visual effect to the electronic device or the external device (e.g., the wearable device 1020 of FIG. 10), but embodiments are not limited thereto, and a tactile effect or an auditory effect may be applied to the electronic device or the external device. For example, the electronic device may apply a tactile effect that causes vibrations to the electronic device or to an external device communicatively connected to the electronic device. At this time, the electronic device may determine the timing of vibration occurrence, a vibration occurrence period, and the number of vibration occurrences using a generative AI model. In another example, the electronic device may apply an auditory effect that generates music to the electronic device or to an external device communicatively connected to the electronic device. At this time, the electronic device may determine the timing of music generation, duration of music generation, and music to be generated using a generative AI model.

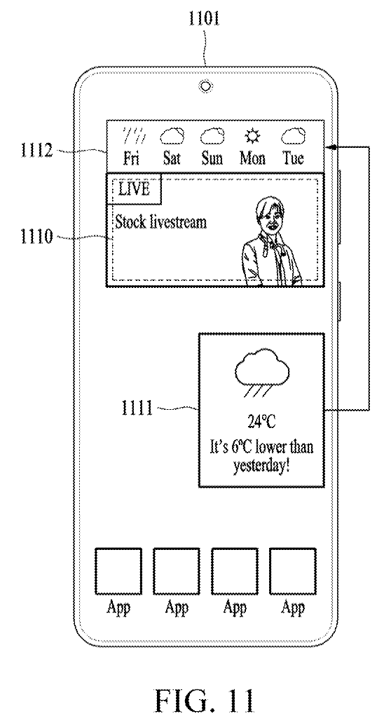

FIG. 11 is a diagram illustrating a process in which an electronic device detects occurrence of an event related to a window to apply a visual effect to the electronic device according to an embodiment.

In an embodiment, an electronic device 1101 (e.g., the electronic device 101 of FIG. 1, the electronic device 301 of FIG. 3, the electronic device 401 of FIG. 4A, the electronic device 501 of FIG. 5, the electronic device 801 of FIG. 8, the electronic device 901 of FIG. 9, or the electronic device 1001 of FIG. 10) may set a window as an object of interest, and detect additional disposition of a window 1110 on a screen of the electronic device 1101 as the occurrence of the event. The electronic device 1101 may apply an effect that changes a position and content of another object (e.g., a widget) disposed on the screen of the electronic device 1101.

For example, the electronic device 1101 may generate a first prompt using first information related to the content displayed in an area of the window 1110 on the screen. The electronic device 1101 may input the content displayed in the area of the window 1110, the first prompt of “stock livestream”, and the widget disposed on the screen into a generative AI model, and the generative AI model may generate an effect that changes the position and the content of the widget. Referring to FIG. 11, a weather-related widget may be displayed on the screen of the electronic device 1101. By applying the effect to the electronic device 1101, the electronic device 1101 may move the position of the widget to the top of the window 1110, and display a content 1112 related to the date and corresponding weather in the area of the moved widget. For example, the content 1112 displayed in the area of the moved widget may be different from a content 1111 displayed in the area of the widget before moving.

An electronic device according to an embodiment may include a processor, and a memory configured to store instructions. The instructions, when performed by the processor, may cause the electronic device to detect occurrence of an event related to an object of interest disposed or to be disposed on a screen of the electronic device, generate a prompt based on the occurred event, and determine an effect to be applied to the electronic device or an external device communicatively connected to the electronic device based on the generated prompt.

The processor may, when a widget is set as the object of interest, detect a change in a content displayed in an area of a first widget disposed on the screen as the occurrence of the event, and generate the prompt using first information related to the content displayed in the area of the first widget.

The first information may include at least one of difference information indicating a difference between a previous content displayed in the area of the widget at a previous time point and a current content displayed in the area of the widget at a current time point, and description information describing the current content.

The processor may, when a widget is set as the object of interest, detect an overlap of areas of two or more widgets disposed on the screen as the occurrence of the event, and generate the prompt using first information related to contents displayed in the respective areas of the two or more widgets.

The processor may, when a window is set as the object of interest, detect disposition of an additional window on the screen as the occurrence of the event, and generate the prompt using first information related to a content displayed in an area of the additional window disposed on the screen.

The processor may, based on inputting an input image displayed on the screen to a visual foundation model, detect one or more objects from the input image through object detection, and identify features and positions of the detected one or more objects, and the object of interest may include one object among the detected one or more objects.

The processor may obtain the effect based on inputting the generated prompt and the content displayed on the object of interest to a generative AI model, which is a machine learning model.

The effect may include at least one of a visual effect, a tactile effect, and an auditory effect.

The processor may, when the determined effect is a visual effect applied to the electronic device, apply the determined effect to another object disposed around the object of interest on the screen.

The processor may obtain position information of one or more objects disposed on the screen, and select the other object based on the obtained position information and the determined effect.

The processor may generate the prompt using first information related to a content displayed in an area of the object of interest and second information related to the external device communicatively connected to the electronic device.

A method performed by a processor of an electronic device according to an embodiment may include detecting occurrence of an event related to an object of interest disposed or to be disposed on a screen of the electronic device, generating a prompt based on the occurred event, and determining an effect to be applied to the electronic device or an external device communicatively connected to the electronic device based on the generated prompt.

The detecting of the occurrence of the event may include, when a widget is set as the object of interest, detecting a change in content displayed in an area of a first widget disposed on the screen as the occurrence of the event, and the generating of the prompt may include generating the prompt using first information related to the content displayed in the area of the first widget.

The detecting of the occurrence of the event may include, when a widget is set as the object of interest, detecting an overlap of areas of two or more widgets disposed on the screen as the occurrence of the event, and the generating of the prompt may include generating the prompt using first information related to contents displayed in the respective areas of the two or more widgets.

The detecting of the occurrence of the event may include, when a window is set as the object of interest, detecting disposition of an additional window on the screen as the occurrence of the event, and the generating of the prompt may include generating the prompt using first information related to a content displayed in an area of the additional window disposed on the screen.

The method performed by the processor of the electronic device according to an embodiment may further include, based on inputting an input image displayed on the screen to a visual foundation model, detecting one or more objects from the input image through object detection, and identifying features and positions of the detected one or more objects, and the object of interest may include one object among the detected one or more objects.

The determining of the effect may include obtaining the effect based on inputting the generated prompt and the content displayed on the object of interest to a generative AI model, which is a machine learning model.

The method performed by the processor of the electronic device according to an embodiment may further include, when the determined effect is a visual effect applied to the electronic device, applying the determined effect to another object disposed around the object of interest on the screen.

The applying of the determined effect to the other object may include obtaining position information of one or more objects disposed on the screen, and selecting the other object based on the obtained position information and the determined effect.

The generating of the prompt may include generating the prompt using first information related to a content displayed in an area of the object of interest and second information related to the external device communicatively connected to the electronic device.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic device is not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof. As used herein, such terms as “1st” and “2nd,” or “first” and “second” may be used to simply distinguish a corresponding component from another, and do not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wired), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include code generated by a compiler or code executable by an interpreter. The machine-readable storage medium may be provided in the form of a non-transitory storage medium. Wherein, the term “non-transitory” simply means that the storage medium is a tangible device, but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. If distributed online, at least part of the computer program product may be temporarily generated or at least temporarily stored in the machine-readable storage medium, such as memory of the manufacturer’s server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The embodiments described herein may be implemented using hardware components, software components, or a combination thereof. For example, the device, the method, and the components described in the embodiments may be implemented using a general-purpose or special-purpose computer, such as a processor, a controller and an arithmetic logic unit (ALU), a digital signal processor (DSP), a microcomputer, a FPGA, a programmable logic unit (PLU), a microprocessor, or any other devices capable of responding to and executing instructions. A processing device may run an operating system (OS) and a software application that runs on the OS. The processing device may also access, store, manipulate, process, and generate data in response to execution of software. For purpose of simplicity, the description of a processing device is used as singular; however, one skilled in the art will appreciate that a processing device may include a plurality of processing elements and/or a plurality of types of processing elements. For example, the processing device may include a plurality of processors or a single processor and a single controller. In addition, different processing configurations are possible, such as parallel processors.

Software may include a computer program, a piece of code, an instruction, or one or more combinations thereof, to independently or collectively instruct or configure a processing device to operate as desired. Software and/or data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording media.

The method according to the embodiments described above may be recorded in non-transitory computer-readable storage media including program instructions to implement various operations of the embodiments described above. The media may also include, alone or in combination with the program instructions, data files, data structures, and the like. The program instructions recorded on the media may be those specially designed and constructed for the purposes of embodiments, or they may be of the kind available to those having skill in the computer software arts. Examples of non-transitory computer-readable media include magnetic media such as hard disks, floppy disks, and magnetic tape, optical media such as compact disc read-only memory (CD-ROM) discs and digital video discs (DVDs), magneto-optical media such as floptical disks, and hardware devices that are specifically configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The hardware devices described above may be configured to act as one or more software modules in order to perform the operations of the embodiments described above, or vice versa.

What is claimed is:

1. An electronic device comprising:
at least one processor; and
a memory configured to store instructions,
wherein the instructions, when performed by the at least one processor, cause the electronic device to:
detect an occurrence of an event related to an object of interest disposed or to be disposed on a screen of the electronic device;
generate a prompt based on the occurrence of the event; and
determine an effect to be applied to the electronic device or an external device communicatively connected to the electronic device based on the generated prompt.

2. The electronic device of claim 1, wherein the instructions, when performed by the at least one processor, further cause the electronic device to:
when a widget is set as the object of interest, detect a change in a content displayed in an area of a first widget disposed on the screen as the occurrence of the event; and
generate the prompt using first information related to the content displayed in the area of the first widget.

3. The electronic device of claim 2, wherein the first information comprises at least one of difference information indicating a difference between a previous content displayed in the area of the first widget at a previous time point and a current content displayed in the area of the first widget at a current time point, and description information describing the current content.

4. The electronic device of claim 1, wherein the instructions, when performed by the at least one processor, further cause the electronic device to:
when a widget is set as the object of interest, detect an overlap of areas of two or more widgets disposed on the screen as the occurrence of the event; and
generate the prompt using first information related to contents displayed in the respective areas of the two or more widgets.

5. The electronic device of claim 1, wherein the instructions, when performed by the at least one processor, further cause the electronic device to:
when a window is set as the object of interest, detect disposition of an additional window on the screen as the occurrence of the event; and
generate the prompt using first information related to a content displayed in an area of the additional window disposed on the screen.

6. The electronic device of claim 1, wherein the instructions, when performed by the at least one processor, further cause the electronic device to:
based on inputting an input image displayed on the screen to a visual foundation model, detect one or more objects from the input image through object detection; and
identify features and positions of the detected one or more objects, and
wherein the object of interest comprises one object among the detected one or more objects.

7. The electronic device of claim 1, wherein the instructions, when performed by the at least one processor, further cause the electronic device to obtain the effect based on inputting the generated prompt and a content displayed on the object of interest to a generative artificial intelligence (AI) model, which is a machine learning (ML) model.

8. The electronic device of claim 1, wherein the determined effect comprises at least one of a visual effect, a tactile effect, and an auditory effect.

9. The electronic device of claim 1, wherein the instructions, when performed by the at least one processor, further cause the electronic device to, when the determined effect is a visual effect applied to the electronic device, apply the determined effect to another object disposed around the object of interest on the screen.

10. The electronic device of claim 1, wherein the instructions, when performed by the at least one processor, further cause the electronic device to:
obtain position information of one or more objects disposed on the screen; and
select another object based on the obtained position information and the determined effect.

11. The electronic device of claim 1, wherein the instructions, when performed by the at least one processor, further cause the electronic device to generate the prompt using first information related to a content displayed in an area of the object of interest and second information related to the external device communicatively connected to the electronic device.

12. A method performed by at least one processor of an electronic device, the method comprising:
detecting an occurrence of an event related to an object of interest disposed or to be disposed on a screen of the electronic device;
generating a prompt based on the occurred event; and
determining an effect to be applied to the electronic device or an external device communicatively connected to the electronic device based on the generated prompt.

13. The method of claim 12, wherein the detecting of the occurrence of the event comprises, when a widget is set as the object of interest, detecting a change in content displayed in an area of a first widget disposed on the screen as the occurrence of the event, and
the generating of the prompt comprises generating the prompt using first information related to the content displayed in the area of the first widget.

14. The method of claim 12, wherein the detecting of the occurrence of the event comprises, when a widget is set as the object of interest, detecting an overlap of areas of two or more widgets disposed on the screen as the occurrence of the event, and
the generating of the prompt comprises generating the prompt using first information related to contents displayed in the respective areas of the two or more widgets.

15. The method of claim 12, wherein the detecting of the occurrence of the event comprises, when a window is set as the object of interest, detecting disposition of an additional window on the screen as the occurrence of the event, and
the generating of the prompt comprises generating the prompt using first information related to a content displayed in an area of the additional window disposed on the screen.

16. The method of claim 12, further comprising:
based on inputting an input image displayed on the screen to a visual foundation model, detecting one or more objects from the input image through object detection; and
identifying features and positions of the detected one or more objects,
wherein the object of interest comprises one object among the detected one or more objects.

17. The method of claim 12, wherein the determining of the effect comprises:
obtaining the effect based on inputting the generated prompt and a content displayed on the object of interest to a generative artificial intelligence (AI) model, which is a machine learning (ML) model.

18. The method of claim 12, further comprising, when the determined effect is a visual effect applied to the electronic device, applying the determined effect to another object disposed around the object of interest on the screen.

19. The method of claim 18, wherein the applying of the determined effect to the another object comprises:
obtaining position information of one or more objects disposed on the screen; and
selecting the another object based on the obtained position information and the determined effect.

20. The method of claim 12, wherein the generating of the prompt comprises: generating the prompt using first information related to a content displayed in an area of the object of interest and second information related to the external device communicatively connected to the electronic device.
